(19) United States
(12) Patent Application Publication
(10) Pub. No.: US 2025/0209339 A1
(43) Pub. Date: Jun. 26, 2025

(54) METHOD AND SYSTEM FOR UTILIZING SYNTHETIC DATA IN ROBUST ADVERSARIAL TRAINING

(71) Applicant: JPMorgan Chase Bank, N.A., New York, NY (US)

(72) Inventors: Eleonora KREACIC, London (GB); Aras SELVI, London (GB); Mohsen GHASSEMI, Jersey City, NJ (US); Vamsi Krishna POTLURU, New York, NY (US); Tucker Richard BALCH, Suwanee, GA (US); Manuela VELOSO, New York, NY (US)

(73) Assignee: JPMorgan Chase Bank, N.A., New York, NY (US)

(21) Appl. No.: 18/391,142

(22) Filed: Dec. 20, 2023

(51) Int. Cl. G06N 3/094

(52) U.S. Cl. CPC G06N 3/094

(57) ABSTRACT

Systems and methods for generating a distributionally robust counterpart for adversarial training of a machine learning model by adjusting an ambiguity set of the training data with respect to synthetic data are provided. The method includes: receiving a first dataset that includes data used for training a machine learning model, the first dataset having a first true distribution and a first empirical distribution; determining a first ambiguity set that relates to the first empirical distribution; obtaining a second dataset that includes synthetic data used for countering adversity with respect to the first dataset, the second dataset having a second true distribution and a second empirical distribution; determining a second ambiguity set that relates to the second empirical distribution; determining a third ambiguity set by obtaining an intersection between the first and second ambiguity sets; and training the machine learning model by using the third ambiguity set.

### BACKGROUND

### 1. Field of the Disclosure

This technology generally relates methods and systems for counteracting adversarial attacks with respect to inputs for machine learning models, and more particularly to methods and systems for generating a distributionally robust counterpart for adversarial training of a machine learning model by adjusting an ambiguity set of the training data with respect to synthetic data.

### 2. Background Information

In recent years, there has been a surge of interest in utilizing synthetic data in order to improve adversarial robustness of machine learning models. It has previously been demonstrated that training a classifier with additional unlabelled data from the same distribution helps adversarial robustness. A showing has been made as to how unlabelled data from a different domain/distribution improves adversarial robustness in the original domain. An investigation into how adversarial robustness of a classifier trained on synthetic data from a proxy distribution translates to the robustness on the real data has been done, thereby highlighting the importance of quantifying the distance between real and proxy data distribution.

In comparison to data arising from a related domain/proxy distribution, the advantage of relying on a synthetic data generator trained on real data is that control over the distance between real and synthetic distribution often comes for free as a consequence of theoretical guarantees on the fidelity of the chosen generator. In particular, a Wasserstein generative adversarial network (GAN) for example achieves the closeness between the training data and the generator in terms of Wasserstein-1 distance and so the generator is guaranteed to live within a small ball around the training distribution.

The concept of adversarial robustness is designed to protect against adversarial attacks, however, it is typically still prone to overfitting. Conversely, for non-adversarial settings, distributionally robust optimization hedges against overfitting by learning over the worst-case data distribution realization from an ambiguity set (i.e., ball) built around the empirical (i.e., real data) distribution.

Accordingly, there is a need for a method for generating a Wasserstein distributionally robust counterpart for adversarial training of a machine learning model by adjusting an ambiguity set of the training data with respect to synthetic data.

### SUMMARY

The present disclosure, through one or more of its various aspects, embodiments, and/or specific features or sub-components, provides, inter alia, various systems, servers, devices, methods, media, programs, and platforms for generating a distributionally robust counterpart for adversarial training of a machine learning model by adjusting an ambiguity set of the training data with respect to synthetic data.

According to an aspect of the present disclosure, a method for generating a distributionally robust counterpart for adversarial training of a machine learning model is provided. The method is implemented by at least one processor. The method includes: receiving, by the at least one processor, a first dataset that includes data that is usable for training a predetermined machine learning model, the first dataset having a first true distribution and a first empirical distribution; determining, by the at least one processor, a first ambiguity set that relates to the first empirical distribution; obtaining, by the at least one processor, a second dataset that includes synthetic data used for countering adversity with respect to the first dataset, the second dataset having a second true distribution and a second empirical distribution; determining, by the at least one processor, a second ambiguity set that relates to the second empirical distribution; determining, by the at least one processor, a third ambiguity set by obtaining an intersection between the first ambiguity set and the second ambiguity set; and training, by the at least one processor, the predetermined machine learning model by using the third ambiguity set.

The first empirical distribution may be constructable by obtaining a first predetermined number of independent and identically distributed samples from the first dataset. The second empirical distribution may be constructable by obtaining a second predetermined number of independent and identically distributed samples from the second dataset.

The obtaining of the second dataset may include adding noise that has a predetermined maximum magnitude to the first dataset.

The predetermined maximum magnitude of the noise may be calculated such that a loss associated with the noise is maximized.

A Wasserstein distance between the first dataset and the second dataset may be less than a predetermined first epsilon value.

The method may further include performing a convex conservative relaxation of a distributionally robust optimization of the third ambiguity set by minimizing a predetermined function of the predetermined first epsilon value while satisfying at least one predetermined constraint.

The predetermined first epsilon value may be calculated by: estimating a second epsilon value based on an estimated Wasserstein distance between the first true distribution and the first empirical distribution; determining a third epsilon value based on a Wasserstein distance between the first true distribution and the second true distribution; and adding the second epsilon value to the third epsilon value to determine a minimum value for the predetermined first epsilon value.

The determining of the third epsilon value may be based on the predetermined maximum magnitude of the noise added to the first dataset in order to generate the second dataset.

Alternatively, the determining of the third epsilon value may include using a predetermined cross-validation process with respect to the first dataset and the second dataset.

According to another exemplary embodiment, a computing apparatus for generating a distributionally robust counterpart for adversarial training of a machine learning model is provided. The computing apparatus includes a processor; a memory; and a communication interface coupled to each of the processor and the memory. The processor is configured to: receive, via the communication interface, a first dataset that includes data that is usable for training a predetermined machine learning model, the first dataset having a first true distribution and a first empirical distribution; determine a first ambiguity set that relates to the first empirical distribution; obtain a second dataset that includes synthetic data used for countering adversity with respect to the first dataset, the second dataset having a second true distribution and a second empirical distribution; determine a second ambiguity set that relates to the second empirical distribution; determine a third ambiguity set by obtaining an intersection between the first ambiguity set and the second ambiguity set; and train the predetermined machine learning model by using the third ambiguity set.

The first empirical distribution may be constructable by obtaining a first predetermined number of independent and identically distributed samples from the first dataset. The second empirical distribution may be constructable by obtaining a second predetermined number of independent and identically distributed samples from the second dataset.

The processor may be further configured to obtain the second dataset by adding noise that has a predetermined maximum magnitude to the first dataset.

The predetermined maximum magnitude of the noise may be calculated such that a loss associated with the noise is maximized.

A Wasserstein distance between the first dataset and the second dataset may be less than a predetermined first epsilon value.

The processor may be further configured to perform a convex conservative relaxation of a distributionally robust optimization of the third ambiguity set by minimizing a predetermined function of the predetermined first epsilon value while satisfying at least one predetermined constraint.

The processor may be further configured to calculate the predetermined first epsilon value by: estimating a second epsilon value based on an estimated Wasserstein distance between the first true distribution and the first empirical distribution; determining a third epsilon value based on a Wasserstein distance between the first true distribution and the second true distribution; and adding the second epsilon value to the third epsilon value to determine a minimum value for the predetermined first epsilon value.

The processor may be further configured to determine the third epsilon value based on the predetermined maximum magnitude of the noise added to the first dataset in order to generate the second dataset.

Alternatively, the processor may be further configured to determine the third epsilon value by using a predetermined cross-validation process with respect to the first dataset and the second dataset.

According to yet another exemplary embodiment, a non-transitory computer readable storage medium storing instructions for generating a distributionally robust counterpart for adversarial training of a machine learning model is provided. The storage medium includes executable code which, when executed by a processor, causes the processor to: receive a first dataset that includes data that is usable for training a predetermined machine learning model, the first dataset having a first true distribution and a first empirical distribution; determine a first ambiguity set that relates to the first empirical distribution; obtain a second dataset that includes synthetic data used for countering adversity with respect to the first dataset, the second dataset having a second true distribution and a second empirical distribution; determine a second ambiguity set that relates to the second empirical distribution; determine a third ambiguity set by obtaining an intersection between the first ambiguity set and the second ambiguity set; and train the predetermined machine learning model by using the third ambiguity set.

The first empirical distribution may be constructable by obtaining a first predetermined number of independent and identically distributed samples from the first dataset. The second empirical distribution may be constructable by obtaining a second predetermined number of independent and identically distributed samples from the second dataset.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary computer system.

FIG. 2 illustrates an exemplary diagram of a network environment.

FIG. 3 shows an exemplary system for implementing a method for generating a distributionally robust counterpart of adversarial training for a machine learning model by adjusting an ambiguity set of the training data with respect to synthetic data.

FIG. 4 is a flowchart of an exemplary process for implementing a method for generating a distributionally robust counterpart for adversarial training of a machine learning model by adjusting an ambiguity set of the training data with respect to synthetic data.

FIG. 5 is an illustration of how adversarial training optimizes an expected adversarial loss over an empirical distribution as reflected in an execution of a method for generating a distributionally robust counterpart for adversarial training of a machine learning model by adjusting an ambiguity set of the training data with respect to synthetic data, according to an exemplary embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

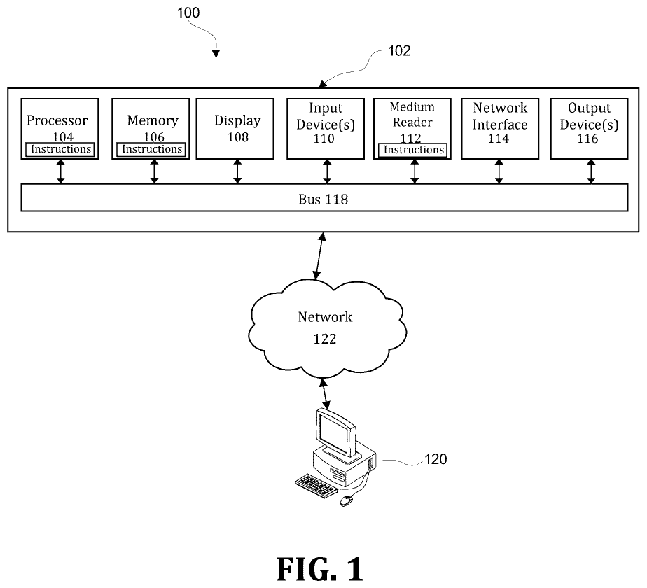

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data as well as executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g. software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As illustrated in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is illustrated in FIG. 1 as a wireless network, those skilled in the art appreciate that the network 122 may also be a wired network.

The additional computer device 120 is illustrated in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide optimized methods and systems for generating a distributionally robust counterpart for adversarial training of a machine learning model by adjusting an ambiguity set of the training data with respect to synthetic data.

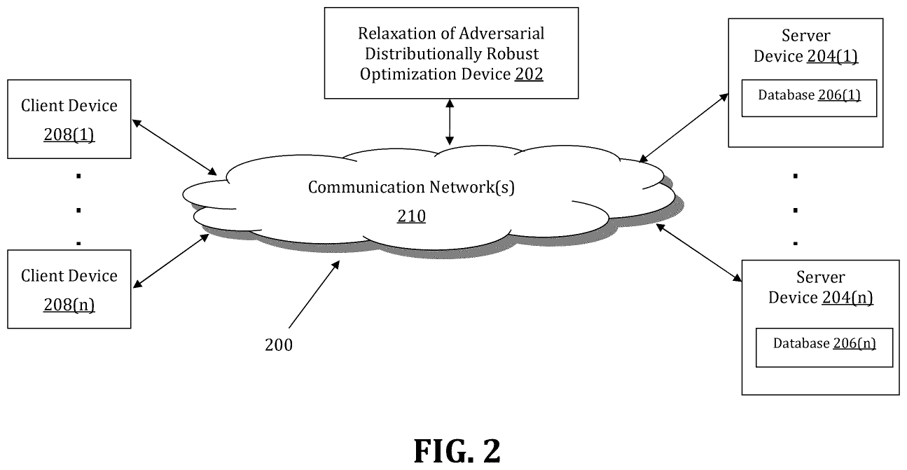

Referring to FIG. 2, a schematic of an exemplary network environment 200 for implementing a method for generating a distributionally robust counterpart for adversarial training of a machine learning model by adjusting an ambiguity set of the training data with respect to synthetic data is illustrated. In an exemplary embodiment, the method is executable on any networked computer platform, such as, for example, a personal computer (PC).

The method for generating a distributionally robust counterpart for adversarial training of a machine learning model by adjusting an ambiguity set of the training data with respect to synthetic data may be implemented by a Relaxation of Adversarial Distributionally Robust Optimization (RADRO) device 202. The RADRO device 202 may be the same or similar to the computer system 102 as described with respect to FIG. 1. The RADRO device 202 may store one or more applications that can include executable instructions that, when executed by the RADRO device 202, cause the RADRO device 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the RADRO device 202 itself, may be located in virtual server(s) running in a cloud-based computing environment rather than being tied to one or more specific physical network computing devices. Also, the application(s) may be running in one or more virtual machines (VMs) executing on the RADRO device 202. Additionally, in one or more embodiments of this technology, virtual machine(s) running on the RADRO device 202 may be managed or supervised by a hypervisor.

In the network environment 200 of FIG. 2, the RADRO device 202 is coupled to a plurality of server devices 204(1)-204(n) that hosts a plurality of databases 206(1)-206(n), and also to a plurality of client devices 208(1)-208(n) via communication network(s) 210. A communication interface of the RADRO device 202, such as the network interface 114 of the computer system 102 of FIG. 1, operatively couples and communicates between the RADRO device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the RADRO device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and RADRO devices that efficiently implement a method for generating a distributionally robust counterpart for adversarial training of a machine learning model by adjusting an ambiguity set of the training data with respect to synthetic data.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The RADRO device 202 may be a standalone device or integrated with one or more other devices or apparatuses, such as one or more of the server devices 204(1)-204(n), for example. In one particular example, the RADRO device 202 may include or be hosted by one of the server devices 204(1)-204(n), and other arrangements are also possible. Moreover, one or more of the devices of the RADRO device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the RADRO device 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store information that relates to true and empirical distributions for datasets and information that relates to Wasserstein distances and associated epsilon values with respect to corresponding pairs of datasets.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the RADRO device 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the RADRO device 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the RADRO device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the RADRO device 202, the server devices 204(1)-204(n), or the client devices 208(1)-208(n), for example, may be configured to operate as virtual instances on the same physical machine. In other words, one or more of the RADRO device 202, the server devices 204(1)-204(n), or the client devices 208(1)-208(n) may operate on the same physical device rather than as separate devices communicating through communication network(s) 210. Additionally, there may be more or fewer RADRO devices 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

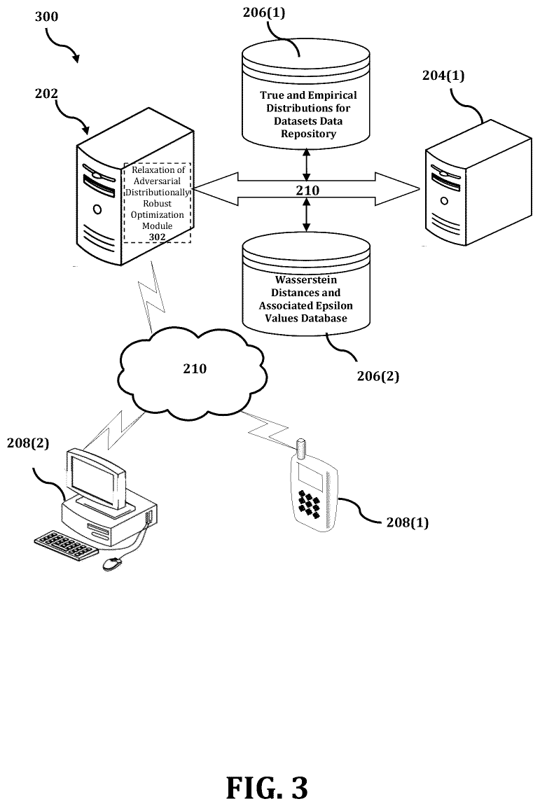

The RADRO device 202 is described and illustrated in FIG. 3 as including a relaxation of adversarial distributionally robust optimization module 302, although it may include other rules, policies, modules, databases, or applications, for example. As will be described below, the relaxation of adversarial distributionally robust optimization module 302 is configured to implement a method for generating a distributionally robust counterpart for adversarial training of a machine learning model by adjusting an ambiguity set of the training data with respect to synthetic data.

An exemplary process 300 for implementing a mechanism for generating a distributionally robust counterpart for adversarial training of a machine learning model by adjusting an ambiguity set of the training data with respect to synthetic data by utilizing the network environment of FIG. 2 is illustrated as being executed in FIG. 3. Specifically, a first client device 208(1) and a second client device 208(2) are illustrated as being in communication with RADRO device 202. In this regard, the first client device 208(1) and the second client device 208(2) may be “clients” of the RADRO device 202 and are described herein as such. Nevertheless, it is to be known and understood that the first client device 208(1) and/or the second client device 208(2) need not necessarily be “clients” of the RADRO device 202, or any entity described in association therewith herein. Any additional or alternative relationship may exist between either or both of the first client device 208(1) and the second client device 208(2) and the RADRO device 202, or no relationship may exist.

Further, RADRO device 202 is illustrated as being able to access a true and empirical distributions for datasets data repository 206(1) and a Wasserstein distances and associated epsilon values database 206(2). The relaxation of adversarial distributionally robust optimization module 302 may be configured to access these databases for implementing a method for generating a distributionally robust counterpart for adversarial training of a machine learning model by adjusting an ambiguity set of the training data with respect to synthetic data.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an exemplary embodiment, either or both of the first client device 208(1) and the second client device 208(2) may communicate with the RADRO device 202 via broadband or cellular communication. Of course, these embodiments are merely exemplary and are not limiting or exhaustive.

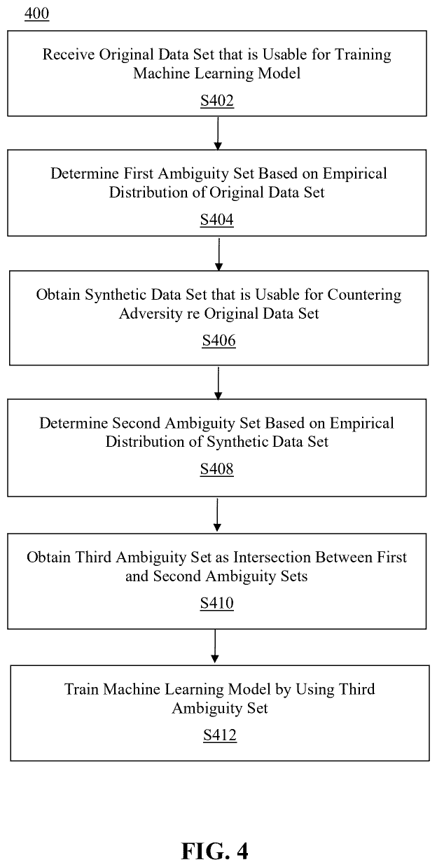

Upon being started, the relaxation of adversarial distributionally robust optimization module 302 executes a process for generating a distributionally robust counterpart for adversarial training of a machine learning model by adjusting an ambiguity set of the training data with respect to synthetic data. An exemplary process for generating a distributionally robust counterpart for adversarial training of a machine learning model by adjusting an ambiguity set of the training data with respect to synthetic data is generally indicated at flowchart 400 in FIG. 4.

In process 400 of FIG. 4, at step S402, the relaxation of adversarial distributionally robust optimization module 302 receives a set of original data that is usable for training a machine learning model. The original data set has a true distribution, but in many instances, it may be difficult to know exactly what the true distribution is. Therefore, in an exemplary embodiment, an empirical distribution for the original data set is constructed by obtaining a predetermined number N of independent and identically distributed samples from the original data set and then using the N samples to determine the empirical distribution.

At step S404, the relaxation of adversarial distributionally robust optimization module 302 uses the empirical distribution of the original data set to determine a first ambiguity set. In an exemplary embodiment, the first ambiguity set may be understood as the equivalent of a sphere or ball that surrounds the N samples of the original data set.

At step S406, the relaxation of adversarial distributionally robust optimization module 302 obtains a synthetic data set that is usable for countering adversity with respect to the original data set. In this aspect, the synthetic data set may be obtained by generating the synthetic data set or by receiving the synthetic data set. In an exemplary embodiment, the synthetic data set may be generated by adding a noise vector having a predetermined maximum magnitude to the original data set. The predetermined maximum magnitude may be calculated such that a loss associated with the noise is maximized. The synthetic data set also has a true distribution, and similarly as described above with respect to the original data set, an empirical distribution for the synthetic data set may be constructed by obtaining a predetermined number M of independent and identically distributed samples from the synthetic data set. In an alternative exemplary embodiment, the synthetic data set may be received, for example, from another region that is usable for making adjustments.

At step S408, the relaxation of adversarial distributionally robust optimization module 302 uses the empirical distribution of the synthetic data set to determine a second ambiguity set. In an exemplary embodiment, the second ambiguity set may be understood as the equivalent of a sphere or ball that surrounds the M samples of the synthetic data set.

At step S410, the relaxation of adversarial distributionally robust optimization module 302 determines a third ambiguity set by obtaining an intersection between the first ambiguity set and the second ambiguity set. In an exemplary embodiment, a convex conservative relaxation of the third ambiguity set is performable by minimizing a predetermined function of an epsilon value ε that is less than a Wasserstein distance between the original data set and the synthetic data set while satisfying at least one predetermined constraint. This convex conservative relaxation operation is described in further detail below. Then, at step S410, the relaxation of adversarial distributionally robust optimization module 302 uses the third ambiguity set to adversarially train the machine learning model in a manner.

In an exemplary embodiment, the epsilon value ε that relates to the Wasserstein distance between the original data set and the synthetic data set may be calculated by using two different approaches, both of which entail estimating an epsilon value ε₁ that is based on an estimated Wasserstein distance between the true distribution and the empirical distribution for the original data set, and both of which also entail determining another epsilon value ε₂ that is based on the Wasserstein distance between the true distribution for the original data set and the true distribution for the synthetic data set. For both approaches, the epsilon value ε is calculated by first adding the epsilon values ε₁ and ε₂ together and then using the sum thereof as a minimum value for the epsilon value ε; i.e., ε₁+ε₂≤ε. The difference between the two approaches is as follows: In the first approach, it is assumed that the epsilon value ε₂ is known; for example, it may be based on the predetermined maximum magnitude of the noise that is added to the original data set in order to generate the synthetic data set. When the epsilon value is not known, then the second approach may be employed, by which a predetermined cross-validation process is executed with respect to the original data set and the synthetic data set.

When the inputs of a machine learning model are subject to adversarial attacks, standard stationarity assumptions on the training and test sets are violated, typically making empirical risk minimization (ERM) ineffective. Adversarial training, which imitates the adversary during the training stage, has thus emerged as the de facto standard for hedging against adversarial attacks. Although adversarial training provides some robustness over ERM, it can still be subject to overfitting, which explains why recent work mixing the training set with synthetic data obtains improved out-of-sample performances.

Inspired by these observations, the present inventive concept provides a Wasserstein distributionally robust (DR) counterpart of adversarial training for improved generalization, together with a recipe for further reducing the conservatism of this approach by adjusting its ambiguity set with respect to synthetic data. The underlying optimization problem, DR adversarial training with synthetic data, is nonconvex and comprises infinitely many constraints. To this end, by using results from robust optimization and convex analysis, tractable relaxations are employed. The analyses described herein focus on the logistic loss function and provide discussions for adapting this framework to other loss functions.

In the present disclosure, an exploration regarding how synthetic data helps to achieve both adversarial and distributional robustness is described. With reference to an ambiguity set (i.e., ball) built around the empirical (i.e., real data) distribution for an original data set, it has been found that synthetic data provides a “direction” along which to travel from the center of the ball in our search for the true distribution. In this regard, reliance upon synthetic data is employed in order to identify an appropriate fraction of the ball and thusly reduce the conservatism of distributionally robust optimization. Accordingly, one objective of the present inventive concept is to utilize synthetic data for model generalization.

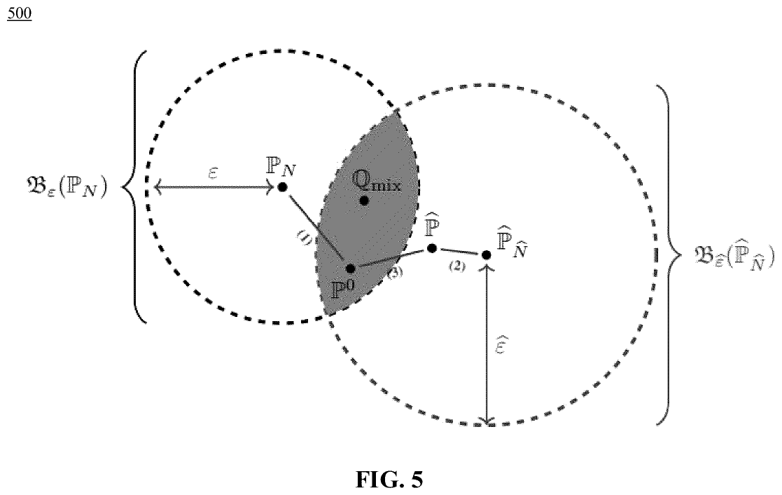

FIG. 5 is an illustration 500 of how adversarial training optimizes an expected adversarial loss over an empirical distribution as reflected in an execution of a method for generating a distributionally robust counterpart for adversarial training of a machine learning model by adjusting an ambiguity set of the training data with respect to synthetic data, according to an exemplary embodiment. As illustrated in FIG. 5, adversarial training Adv optimizes an expected adversarial loss over an empirical distribution [symbol] _{N}. Replacing [symbol] _{N} with the worst-case distribution in an ambiguity set [symbol] _{c}( [symbol] _{N}) built around it yields the distributionally robust adversarial training problem referred to herein as AdvDRO. To reduce conservatism of [symbol] _{g}( [symbol] _{N}), it is intersected with another ball that surrounds a synthetic empirical distribution [symbol] _{\hat{ε}}( [symbol] _{\hat{N}}). This intersection includes [symbol] ⁰ if \hat{ε} overestimates (2)+(3) for which confidence bounds can be provided; for example, fidelity guarantees on the synthetic generator and finite-sample statistics may be used for obtaining such confidence bounds.

In an exemplary embodiment, the overarching question addressed herein is: What is the value of synthetic data in the context of model robustness? FIG. 5 provides an illustration 500 of the problem setting. The present inventive concept provides the following: 1) There is a showing that logistic loss adversarial training is equivalent to empirical risk minimization for a new loss function and is consequently prone to overfitting. 2) A tractable convex optimization reformulation is provided for both adversarially and Wasserstein distributionally robust optimization with logistic loss. 3) To reduce the conservatism of adversarially and distributionally robust optimization, a variant thereof is derived, in which the distributional ambiguity is replaced with the intersection of Wasserstein balls built around the real and synthetic data. Further, a description regarding when this approach is meaningful is provided, together with a rigorous theoretical analysis to derive tractable approximation schemes by unifying the robust optimization, adversarial training, and synthetic data fields.

Problem Setting and Preliminaries: Consideration is given to a binary classification problem where an instance is modeled as (x, y)∈Ξ:=Rn×{−1, +1}. There is a specific focus on logistic regression, as it provides a particularly favorable ground to explore the relationship between adversarial robustness and ERM. More precisely, the labels depend on the features probabilistically with the following expression:

$$Prob [ y \vert x ] = {[ 1 + exp ( - y \cdot {β}^{T} x ) ]}^{- 1}$$

for some β∈ [symbol] ⁿ; its associated loss is the logloss function

$${ℓ}_{β} ( x , y ) := log ( 1 + exp ( - y \cdot {β}^{T} x ) ) .$$

Table 1 below provides a summary of several training paradigms and a comparison of risks taken therein.

| | ERM | DRO | Adv |
|---|---|---|---|
| Train- ing risk | [symbol] _{N} [ [symbol] _{β} (x, y)] | ${𝔼}_{ℚ} [ {ℓ}_{β} ( x , y ) ]$ | ${𝔼}_{{ℙ}_{N}} [ {sup}_{z : {‖ z ‖}_{p} \leq α} \{ {ℓ}_{β} ( x + z , y ) \} ]$ |
| True risk | [symbol] 0 [ [symbol] (x, y)] | [symbol] 0 [ [symbol] _{β} (x,y)] | ${𝔼}_{ℙ 0} [ {sup}_{z : {‖ z ‖}_{p} \leq α} \{ {ℓ}_{β} ( x + z , y ) \} ]$ |

Distributional ambiguity measures and sets: Let P(Ξ) denote the set of probability distributions supported on Ξ. In an exemplary embodiment, the Wasserstein distance is employed to model distributional ambiguity. Before defining the Wasserstein distance on P(Ξ), the following feature-label metric on Ξ is introduced.

Definition 1. The distance d(ξ, ξ′) between ξ=(x, y)∈Ξ and ξ′=(x′, y′)∈Ξ is the standard feature-label metric d(ξ,ξ′)=∥x−x′∥_{q}+κ· [symbol] [y≠y′] for κ>0 controlling the label weight and q>0 specifying a rational norm on [symbol] ⁿ.

Using Definition 1, a definition is provided for the Wasserstein distance.

Definition 2. The type-1 Wasserstein distance between distributions Q E P(Ξ) and Q′∈P(Ξ), for the feature-label metric d(ξ, ξ′) on Ξ, is defined as

$$W ( ℚ , {ℚ}^{′} ) = {inf}_{\prod ∈ P ( Ξ \times Ξ )} \{ {\int }_{Ξ \times Ξ} d ( ξ , {ξ}^{′} ) \prod ( d ξ , d {ξ}^{′} ) : \prod ( d ξ , Ξ ) = ℚ ( d ξ ) , \prod ( Ξ , d {ξ}^{′} ) = {ℚ}^{′} ( d {ξ}^{′} ) \} .$$

For a fixed ε>0, the Wasserstein ambiguity set of P∈P(Ξ) is defined as

$$ℙ ∈ 𝒫 ( Ξ ) as {ε}_{} ( ℙ ) := \{ ℚ ∈ 𝒫 ( Ξ ) : W ( ℚ , ℙ ) \leq ε \} .$$

Empirical Risk Minimization: By allowing [symbol] ⁰ to denote the true data generating distribution, then one ideally wants to minimize the expected loss over [symbol] ⁰, represented as the following problem:

$${minimize}_{β ∈ {ℝ}^{n}} \qquad {𝔼}_{ℙ 0} [ {ℓ}_{β} ( x , y ) ] .$$

In practice, [symbol] ⁰ is hardly ever known, and one thus resorts to the empirical distribution

$${ℙ}_{N} = \frac{1}{N} {\sum }_{i ∈ [ N ]} {δ}_{{ξ}^{i}} where {\{ {ξ}^{i} = ( {x}^{i} , {y}^{i} ) \}}_{i ∈ [ N ]}$$

are independent and identically distributed. samples from P0 and δ_{ξ} denotes the Dirac distribution supported on ξ. Thus, the empirical risk minimization (ERM) problem is

$$\begin{matrix}{minimize}_{β ∈ {ℝ}^{n}} & {𝔼}_{{ℙ}_{N}} [ {ℓ}_{β} ( x , y ) ] = \frac{1}{N} {\sum }_{i ∈ [ N ]} {ℓ}_{β} ( {x}^{i} , {y}^{i} ) .\end{matrix} \qquad ( ERM )$$

Distributionally Robust Optimization (DRO): It is well understood that in non-asymptotic settings, ERM may suffer from overfitting or optimism bias. DRO is an optimization approach that attempts to address this issue. DRO is motivated by the fact that in the finite-data setting, the ambiguity between the true and empirical distributions is positive but upper-bounded by some ε>0. When the ambiguity is measured by Wasserstein distance 2, this means that [symbol] ⁰∈ [symbol] _{ε}( [symbol] _{N}). The goal in DRO is to optimize the expected loss over the worst possible realization of the true distribution in [symbol] _{ε}( [symbol] _{N}). That is,

$$\begin{matrix}{minimize}_{β ∈ {ℝ}^{n}} & & {𝔼}_{ℚ} [ {ℓ}_{β} ( x , y ) ] .\end{matrix} \qquad ( DRO )$$

Adversarial Robustness: Another popular approach to improve over the generalization performance of ERM is adversarial robustness, where the goal is to provide robustness against adversarial attacks. An adversarial attack, in the widely studied lₚ-noise setting, perturbs the features of the test instances (x, y) by adding additive noise z to x. The adversary chooses the noise vector z, subject to ∥z∥p≤α, so as to maximize the loss [symbol] _{β}(x+z, y) associated with this perturbed test instance. Therefore, in adversarial training, one can solve the following optimization problem in the training stage to hedge against adversarial perturbations at test time:

$$\begin{matrix}{minimize}_{β ∈ {ℝ}^{n}} & {𝔼}_{{ℙ}_{N}} [ {sup}_{z : {‖ z ‖}_{p} \leq α} \{ {ℓ}_{β} ( x + z , y ) \}\end{matrix} ] . \qquad ( Adv )$$

Note that Adv reduces to ERM when α=0. It is worth noting that Adv is identical to feature robust training, which does not have adversarial attacks, but the training set comprises noisy observations of the features, hence one employs robust optimization.

Distributionally Robust Adversarial Training: Problems Adv and ERM of logistic regression differ from one another in their objective functions. However, the following lemma shows that Problem Adv is nothing but an ERM problem for a different loss function.

Lemma 1: Problem Adv is identical to

$${minimize}_{β ∈ {ℝ}^{n}} \qquad {𝔼}_{{ℙ}_{N}} [ {ℓ}_{β}^{α} ( x , y ) ] ,$$

$$where$$

$${ℓ}_{β}^{α} ( x , y ) := log ( 1 + exp ( - y \cdot {β}^{⊤} x + α \cdot {‖ β ‖}_{{p}^{*}} ) )$$

is the adversarial loss associated with the logloss. Moreover, the corresponding univariate loss

$${L}^{α} ( z ) := log ( 1 + exp ( - z + α \cdot {‖ β ‖}_{{p}^{*}} ) )$$

satisfies Lip(Lα)=1 for any α>0.

Reducing the Adv to problem ERM with loss function [symbol] ^{α}_{β} (x, y) highlights that adversarial training is prone to overfitting. In order to circumvent this obstacle, a derivation of a distributionally robust counterpart of adversarial training is provided below. The following is an expression for a distributionally and adversarially robust optimization problem:

$$\begin{matrix}{minimize}_{β ∈ {ℝ}^{n}} & {𝔼}_{ℚ} [ {sup}_{z : {‖ z ‖}_{p} \leq α} \{ {ℓ}_{β} ( x + z , y ) \}\end{matrix} ] . \qquad ( AdvDRO )$$

Solving Problem AdvDRO requires the following assumption.

Assumption 1. There exists ε>0 known to the decision maker so that [symbol] ⁰∈ [symbol] _{ε}( [symbol] _{N}).

As a corollary of Lemma 1, AdvDRO has a tractable reformulation.

Corollary 1. Problem AdvDRO admits the following tractable convex optimization reformulation:

$$\begin{matrix}{minimize}_{β , λ , s} & λ \cdot ε + \frac{1}{N} {\sum }_{i ∈ [ N ]} {s}_{i} & \\ subject to & log ( 1 + exp ( - {y}^{i} \cdot {β}^{⊤} {x}^{i} + α \cdot {‖ β ‖}_{{p}^{*}} ) ) \leq {s}_{i} & ∀ i ∈ [ N ] \\ & log ( 1 + exp ( {y}^{i} \cdot {β}^{⊤} {x}^{i} + α \cdot {‖ β ‖}_{{p}^{*}} ) ) - λ \cdot κ \leq {s}_{i} & ∀ i ∈ [ N ] \\ & {‖ β ‖}_{{q}^{*}} \leq λ & \\ & β ∈ {ℝ}^{n} , λ \geq 0 , s ∈ {ℝ}^{N} , & \end{matrix}$$

Reducing Conservatism with Synthetic Data: The description above relates to a setting where there is access to the empirical distribution [symbol] _{N} that is constructed from N independent and identically distributed samples of [symbol] ⁰. Suppose that there is an additional empirical distribution [symbol] _{\hat{N}} which is constructed from \hat{N} independent and identically distributed samples {\hat{ξ}^{j}=(\hat{x}^{j},ŷ^{j})}_{j∈[\hat{N}]} of another related but non-identical distribution [symbol] The process starts with a strong and unrealistic assumption, that additional data is close enough to [symbol] ⁰:

Assumption 2. There exists \hat{ε}>0 known to the decision maker so that W( [symbol] ⁰, [symbol] _{\hat{N}})≤\hat{ε},

As described above, DRO assumes [symbol] ⁰∈ [symbol] _{ε}( [symbol] _{N}). Under Assumption 2, it also follows that [symbol] ⁰∈ [symbol] _{\hat{ε}}( [symbol] _{\hat{N}}), meaning that [symbol] ⁰∈ [symbol] _{ε}( [symbol] _{N})∩ [symbol] _{\hat{ε}}( [symbol] _{\hat{N}}). It is thus desirable to solve the following variant of AdvDRO where the ambiguity set is modeled as the intersection of two balls, hence providing a weakly less conservative ambiguity set than of AdvDRO:

$$\begin{matrix}\begin{matrix}{minimize}_{β ∈ {ℝ}^{n}} & \end{matrix} & {𝔼}_{ℚ} [ {ℓ}_{β}^{α} ( x , y ) ] ,\end{matrix} \qquad ( Synth )$$

which reduces to AdvDRO when \hat{ε} is sufficiently large so that [symbol] _{ε}( [symbol] _{N})∩ [symbol] _{\hat{ε}}( [symbol] _{\hat{N}})= [symbol] _{ε}( [symbol] _{N}). Note that for Synth to be well-defined, [symbol] _{ε}( [symbol] _{N})∩ [symbol] _{\hat{ε}}( [symbol] _{\hat{N}}) needs to be non-empty.

The inner problem in Synth involves optimizing the worst-case realization Q from an unusual constraint set in the distribution space. To avoid the difficulty of solving such a problem, a tractable convex relaxation of Problem Synth is proposed. The following theorem presents a conservative relaxation to Problem Synth.

Theorem 1. Problem Synth admits the following tractable convex conservative relaxation:

$$\begin{matrix}{minimize}_{β , λ , \hat{λ} , s , \hat{s} , {z}^{+} , {z}^{-}} & ε \cdot λ + \hat{ε} \cdot \hat{λ} + \frac{1}{N} {\sum }_{i = 1}^{N} {s}_{i} +\end{matrix} \frac{1}{\hat{N}} {\sum }_{j = 1}^{\hat{N}} {\hat{s}}_{j}$$

subject to the following constraints:

$$\begin{matrix}{L}^{α} ( {β}^{⊤} {x}^{i} + {z}_{ij}^{+ ⊤} ( {\hat{x}}^{j} - {x}^{i} ) ) \leq {s}_{i} + κ \cdot \frac{1 - {y}^{i}}{2} \cdot λ + {\hat{s}}_{j} + κ \cdot \frac{1 - {y}^{j}}{2} \cdot \hat{λ} & ∀ i ∈ [ N ] , ∀ j ∈ [ \hat{N} ] \\ \begin{matrix}{‖ β - {z}_{ij}^{+} ‖}_{{q}^{*}} \leq λ , & {‖ - β - {z}_{ij}^{-} ‖}_{{q}^{*}} \leq λ , & {‖ {z}_{ij}^{+} ‖}_{{q}^{*}} \leq \hat{λ} , & {‖ {z}_{ij}^{-} ‖}_{{q}^{*}} \leq λ\end{matrix} & ∀ i ∈ [ N ] , ∀ j ∈ [ \hat{N} ] \\ {L}^{α} ( - {β}^{⊤} {x}^{i} + {z}_{ij}^{- ⊤} ( {\hat{x}}^{j} - {x}^{i} ) ) \leq {s}_{i} + κ \cdot \frac{1 + {y}^{i}}{2} \cdot λ + {\hat{s}}_{j} + κ \cdot \frac{1 + {\hat{y}}^{j}}{2} \cdot \hat{λ} & ∀ i ∈ [ N ] , ∀ j ∈ [ \hat{N} ] \\ β ∈ {ℝ}^{n} , λ \geq 0 , \hat{λ} \geq 0 , s ∈ {ℝ}_{+}^{N} , \hat{s} ∈ {ℝ}_{+}^{\hat{N}} , {z}_{ii}^{+} , {z}_{ii}^{-} ∈ {ℝ}^{n} , i ∈ [ N ] , j ∈ [ \hat{N} ] . & \end{matrix} \qquad ( ProxSynth )$$

This formulation admits an exponential cone reformulation, with the same techniques applied to AdvDRO.

The case of uninformative synthetic data: When the synthetic data does not provide any useful information, a selection of \hat{ε} may be large enough to have [symbol] _{ε}( [symbol] _{N})∩ [symbol] _{\hat{ε}}( [symbol] _{\hat{N}})= [symbol] _{ε}( [symbol] _{N}). In this case, problem Synth simply reduces to Problem AdvDRO. The next lemma discusses the same behavior for the relaxed problem ProxSynth, meaning that the presented relaxation will not force learning from the synthetic data, and recovering AdvDRO remains a feasible solution.

Lemma 2. As \hat{ε}→∞, the optimal value of ProxSynth converges to the optimal value of AdvDRO.

The case of unknown ε and \hat{ε}: The following description relates to how to tune the parameters ε and \hat{ε} when they are unknown. This discussion requires understanding the statistical properties of AdvDRO and Synth. First, it is required that [symbol] _{ε}( [symbol] _{N})∩ [symbol] _{\hat{ε}}( [symbol] _{\hat{N}})≠∅ for Synth to be well-defined. To ensure this, a sufficient condition follows from the triangle inequality: ε+\hat{ε}≥W( [symbol] _{N}, [symbol] _{\hat{N}}).

Tuning ε: An objective is to find a tight ε value so that [symbol] ⁰∈ [symbol] _{ε}( [symbol] _{N}) with high confidence. To this end, advantageous use is made of the rich arsenal of finite-sample statistics from the Wasserstein DRO literature. In particular, the optimal value of ε given a confidence level for including in [symbol] ⁰ in [symbol] _{ε}( [symbol] _{N}), asymptotic consistency of AdvDRO, and the existence of sparse worst-case distributions in the nature's problem are available.

Conversely, deciding \hat{ε} is a much more challenging task since it is desired to have [symbol] ⁰∈ [symbol] _{\hat{ε}}( [symbol] _{\hat{N}}), but [symbol] _{\hat{N}} is constructed of independent and identically distributed samples of another distribution [symbol] . Thus, one needs to estimate both \hat{ε}₁:=W( [symbol] _{\hat{N}}, [symbol] _{\hat{N}}) and \hat{ε}₂:=W( [symbol] , [symbol] ⁰). A choice would then be made that \hat{ε}≥\hat{ε}₁+\hat{ε}₂ so as to include [symbol] ⁰ in [symbol] _{\hat{ε}}( [symbol] _{\hat{N}}). In one instance, it may be assumed that Appendix D.2, we first assume that \hat{ε}₂ is known, and it may then be shown that Synth enjoys an optimal characterization of ε and \hat{ε} values that guarantee [symbol] ⁰∈ [symbol] _{ε}( [symbol] _{\hat{N}})∩ [symbol] _{\hat{ε}}( [symbol] _{\hat{N}}) with arbitrarily high confidence. Note that when no knowledge of \hat{ε}₂ exists, cross-validation is then used to tune this parameter.

Regarding the use of synthetic data {(\hat{x}^{j},ŷ^{j})}_{j∈[\hat{N}]} for adversarial training and relating it to the problem Synth, a proposal is made to solve the following problem, for some w>0.

$${minimize}_{β ∈ {ℝ}^{n}} \frac{1}{N + w \cdot \hat{N}} [ {\sum }_{i ∈ [ N ]} {sup}_{{x}^{i} : {‖ {z}^{i} ‖}_{p} \leq α} \{ {ℓ}_{β} ( {x}^{i} + {z}^{i} , {y}^{i} ) \} + w \cdot {\sum }_{j ∈ [ \hat{N} ]} {sup}_{{x}^{j} : {‖ {z}^{j} ‖}_{p} \leq α} \{ {ℓ}_{β} ( {\hat{x}}^{j} + {z}^{j} , {\hat{y}}^{j} ) \} ] , \qquad ( 1 )$$

Proposition 1. Problem (1) is equivalent to

$${min}_{β ∈ {ℝ}^{n}} {𝔼}_{ℚ mix} [ {ℓ}_{β}^{α} ( x , y ) ] where {ℚ}_{mix} := {λℙ}_{N} + ( 1 - λ ) {\hat{ℙ}}_{\hat{N}} for λ = \frac{N}{N + w \cdot \hat{N}} .$$

The following lemma shows that under reasonable conditions for ε and \hat{ε}, the mixture distribution introduced in Proposition 1 is included in [symbol] _{ε}( [symbol] _{N})∩ [symbol] _{\hat{ε}}( [symbol] _{\hat{N}}). This means that the distribution [symbol] ₘᵢₓ used on synthetic data for adversarial training, belongs to the set of distributions considered in Problem Synth.

Lemma 3: For any λ∈(0,1) and distribution [symbol] ₘᵢₓ:=λ· [symbol] _{N}+(1−λ). [symbol] _{\hat{N}}, the following expression is true:

$$For λ = \frac{N}{N + \hat{N}} ,$$

provided that [symbol] _{ε}( [symbol] _{N})∩ [symbol] _{\hat{ε}}( [symbol] _{\hat{N}}) is nonempty, Lemma 3 shows that a sufficient condition for this intersection to include the mixture [symbol] ₘᵢₓ is \hat{ε}/ε=N/\hat{N}, which is intuitive since the radii of the Wasserstein ambiguity sets are typically chosen inversely proportional to the number of samples.

Accordingly, with this technology, an optimized process for generating a distributionally robust counterpart for adversarial training of a machine learning model by adjusting an ambiguity set of the training data with respect to synthetic data is provided.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

What is claimed is:

1. A method for generating a distributionally robust counterpart for adversarial training of a machine learning model, the method being implemented by at least one processor, the method comprising:
receiving, by the at least one processor, a first dataset that includes data that is usable for training a predetermined machine learning model, the first dataset having a first true distribution and a first empirical distribution;
determining, by the at least one processor, a first ambiguity set that relates to the first empirical distribution;
obtaining, by the at least one processor, a second dataset that includes synthetic data used for countering adversity with respect to the first dataset, the second dataset having a second true distribution and a second empirical distribution;
determining, by the at least one processor, a second ambiguity set that relates to the second empirical distribution;
determining, by the at least one processor, a third ambiguity set by obtaining an intersection between the first ambiguity set and the second ambiguity set; and
training, by the at least one processor, the predetermined machine learning model by using the third ambiguity set.

2. The method of claim 1, wherein the first empirical distribution is constructable by obtaining a first predetermined number of independent and identically distributed samples from the first dataset, and the second empirical distribution is constructable by obtaining a second predetermined number of independent and identically distributed samples from the second dataset.

3. The method of claim 1, wherein the obtaining of the second dataset comprises adding noise that has a predetermined maximum magnitude to the first dataset.

4. The method of claim 3, wherein the predetermined maximum magnitude of the noise is calculated such that a loss associated with the noise is maximized.

5. The method of claim 3, wherein a Wasserstein distance between the first dataset and the second dataset is less than a predetermined first epsilon value.

6. The method of claim 5, further comprising performing a convex conservative relaxation of a distributionally robust optimization of the third ambiguity set by minimizing a predetermined function of the predetermined first epsilon value while satisfying at least one predetermined constraint.

7. The method of claim 5, wherein the predetermined first epsilon value is calculated by:
estimating a second epsilon value based on an estimated Wasserstein distance between the first true distribution and the first empirical distribution;
determining a third epsilon value based on a Wasserstein distance between the first true distribution and the second true distribution; and
adding the second epsilon value to the third epsilon value to determine a minimum value for the predetermined first epsilon value.

8. The method of claim 7, wherein the determining of the third epsilon value is based on the predetermined maximum magnitude of the noise added to the first dataset in order to generate the second dataset.

9. The method of claim 7, wherein the determining of the third epsilon value comprises using a predetermined cross-validation process with respect to the first dataset and the second dataset.

10. A computing apparatus for generating a distributionally robust counterpart for adversarial training of a machine learning model, the computing apparatus comprising:
a processor;
a memory; and
a communication interface coupled to each of the processor and the memory,
wherein the processor is configured to:
receive, via the communication interface, a first dataset that includes data that is usable for training a predetermined machine learning model, the first dataset having a first true distribution and a first empirical distribution;
determine a first ambiguity set that relates to the first empirical distribution;
obtain a second dataset that includes synthetic data used for countering adversity with respect to the first dataset, the second dataset having a second true distribution and a second empirical distribution;
determine a second ambiguity set that relates to the second empirical distribution;
determine a third ambiguity set by obtaining an intersection between the first ambiguity set and the second ambiguity set; and
train the predetermined machine learning model by using the third ambiguity set.

11. The computing apparatus of claim 10, wherein the first empirical distribution is constructable by obtaining a first predetermined number of independent and identically distributed samples from the first dataset, and the second empirical distribution is constructable by obtaining a second predetermined number of independent and identically distributed samples from the second dataset.

12. The computing apparatus of claim 10, wherein the processor is further configured to obtain the second dataset by adding noise that has a predetermined maximum magnitude to the first dataset.

13. The computing apparatus of claim 12, wherein the predetermined maximum magnitude of the noise is calculated such that a loss associated with the noise is maximized.

14. The computing apparatus of claim 12, wherein a Wasserstein distance between the first dataset and the second dataset is less than a predetermined first epsilon value.

15. The computing apparatus of claim 14, wherein the processor is further configured to perform a convex conservative relaxation of a distributionally robust optimization of the third ambiguity set by minimizing a predetermined function of the predetermined first epsilon value while satisfying at least one predetermined constraint.

16. The computing apparatus of claim 14, wherein the processor is further configured to calculate the predetermined first epsilon value by:
estimating a second epsilon value based on an estimated Wasserstein distance between the first true distribution and the first empirical distribution;
determining a third epsilon value based on a Wasserstein distance between the first true distribution and the second true distribution; and
adding the second epsilon value to the third epsilon value to determine a minimum value for the predetermined first epsilon value.

17. The computing apparatus of claim 16, wherein the processor is further configured to determine the third epsilon value based on the predetermined maximum magnitude of the noise added to the first dataset in order to generate the second dataset.

18. The computing apparatus of claim 16, wherein the processor is further configured to determine the third epsilon value by using a predetermined cross-validation process with respect to the first dataset and the second dataset.

19. A non-transitory computer readable storage medium storing instructions for generating a distributionally robust counterpart for adversarial training of a machine learning model, the storage medium comprising executable code which, when executed by a processor, causes the processor to:
receive a first dataset that includes data that is usable for training a predetermined machine learning model, the first dataset having a first true distribution and a first empirical distribution;
determine a first ambiguity set that relates to the first empirical distribution;
obtain a second dataset that includes synthetic data used for countering adversity with respect to the first dataset, the second dataset having a second true distribution and a second empirical distribution;
determine a second ambiguity set that relates to the second empirical distribution;
determine a third ambiguity set by obtaining an intersection between the first ambiguity set and the second ambiguity set; and
train the predetermined machine learning model by using the third ambiguity set.

20. The storage medium of claim 19, wherein the first empirical distribution is constructable by obtaining a first predetermined number of independent and identically distributed samples from the first dataset, and the second empirical distribution is constructable by obtaining a second predetermined number of independent and identically distributed samples from the second dataset.
